(19) United States
(12) Patent Application Publication
(10) Pub. No.: US 2025/0070267 A1
(43) Pub. Date: Feb. 27, 2025

(54) ENERGY STORAGE CELL AND METHOD FOR PREPARING ENERGY STORAGE CELL

(71) Applicant: Zhejiang Jinko Energy Storage Co., Ltd., Haining City (CN)

(72) Inventors: Yutao SHI, Haining City (CN); Yujun MA, Haining City (CN); Zixiang YANG, Haining City (CN)

(21) Appl. No.: 18/943,885

(22) Filed: Nov. 11, 2024

(30) Foreign Application Priority Data
Oct. 8, 2024 (CN) 202411396823.0

(51) Int. Cl. H01M 10/0587

(52) U.S. Cl. CPC H01M 10/0587

(57) ABSTRACT

A method for preparing an energy storage cell is provided, and includes: providing a film layer, where the film layer is one of a positive electrode sheet, a separating film, and a negative electrode sheet, and the film layer has a first edge and a second edge opposite the first edge; performing a dispensing treatment on the film layer to form a plurality of groups of glue dots arranged on a surface of the film layer in a first direction; providing remaining two of the positive electrode sheet, the separating film, and the negative electrode sheet, and stacking the negative electrode sheet, the separating film, and the positive electrode sheet sequentially to form a stacked structure; and performing a winding treatment on the stacked structure from the second edge toward the first edge.

### CROSS REFERENCE TO RELATED APPLICATIONS

The present application claims the benefit of priority under the Paris Convention to Chinese Patent Application No. 202411396823.0 filed on Oct. 8, 2024, which is incorporated herein by reference in its entirety.

### TECHNICAL FIELD

The various embodiments described in this document relate in general to the field of energy storage, and more specifically to an energy storage cell and a method for preparing the energy storage cell.

### BACKGROUND

In recent years, lithium-ion batteries have attracted great attention due to their excellent characteristics such as high energy density, high output voltage, low self-discharge rate, long service life, no memory effect, and environmental friendliness. The development of lithium-ion batteries has made rapid progress, with a continuously expanding market share and occupying a dominant position.

The development of the lithium-ion batteries focuses on the cycle stability, preparation cost, and yield of the cells. Current cells mainly include two cells of types to increase energy density, where one type is cells of laminated type and the other type is cells of winding type. The cells of winding type, i.e., the winding core, are the most common way to increase energy density. In the cross section of the cell of winding type, the cell of winding type includes two parts, one is a flat extension region, and the other is a curved bending region. The winding core is formed by winding multi-layer film material. Tension may be generated during winding. Improper tension may cause problems such as bending, wrinkles, and even breaking, which may increase the safety risks of the battery, especially in the curved bending region, separating films are more prone to wrinkles. At present, there are two improvement measures. One of the two improvement measures is to release the stress of the separating film before preparing the lithium battery, which is costly and may cause environmental pollution. The other of the two improvement measures is to change structures of the crystalline region and amorphous region of the separating film to improve the wrinkle resistance of the separating film. However, there may be other problems raised, such as causing excessive self-discharge of the lithium battery, or the high modulus separating film may cause the lithium cell to be more prone to “S”-shaped deformation in recycling use.

Therefore, there is a need to provide a method for preparing an energy storage cell in which the separating film, the positive electrode sheet, and the negative electrode sheet are fixed to each other, to improve the yield rate of the energy storage cell and reduce the preparation cost.

### SUMMARY

Embodiments provide an energy storage cell and a method for preparing the energy storage cell.

According to some embodiments, a method for preparing an energy storage cell is provided. The method includes: providing a film layer, wherein the film layer is one of a positive electrode sheet, a separating film, and a negative electrode sheet, and the film layer has a first edge and a second edge opposite the first edge; performing a dispensing treatment on the film layer to form a plurality of groups of glue dots arranged on a surface of the film layer in a first direction from the first edge to the second edge, wherein a distribution density of glue dots of the plurality of groups of glue dots decreases in a direction from the second edge toward the first edge; providing remaining two of the positive electrode sheet, the separating film, and the negative electrode sheet, and stacking the negative electrode sheet, the separating film, and the positive electrode sheet sequentially to form a stacked structure; and performing a winding treatment on the stacked structure from the second edge toward the first edge, wherein the separating film is positioned between the positive electrode sheet and the negative electrode sheet in the stacked structure, and the winding treatment includes causing the glue dots of the plurality of groups of glue dots to be in a molten state and to form adhesive layers, and fixing the separating film to at least one of the positive electrode sheet and the negative electrode sheet.

In some embodiments, the film layer further has two third edges disposed opposite to each other in a second direction, and each of the two third edges is connected between the first edge and the second edge. During performing of the dispensing treatment on the film layer, a distribution density of glue dots in a same group of glue dots increases in a direction from a center of the film layer in the second direction toward a corresponding third edge of the two third edges.

In some embodiments, a spacing between adjacent glue dots in the same group of glue dots decreases in the direction from the center of the film layer in the second direction toward the corresponding third edge of the two third edges, and/or sizes of the glue dots in the same group of glue dots increase in the direction from the center of the film layer in the second direction toward the corresponding third edge of the two third edges.

In some embodiments, the plurality of groups of glue dots includes a first group of glue dots close to the first edge and a second group of glue dots close to the second edge. A size of each of first glue dots in the first group of glue dots is smaller than a size of a respective second glue dot of second glue dots of the second group of glue dots, and/or a first spacing between each two adjacent first glue dots in the first group of glue dots is greater than a second spacing between a corresponding pair of adjacent second glue dots in the second group of glue dots.

In some embodiments, a ratio of the first spacing to the second spacing is in a range of 1.03 to 1.3.

In some embodiments, a total area of an orthographic projection of the plurality of groups of glue dots on the film layer accounts for 10% to 14% of a surface area of the film layer.

In some embodiments, the winding treatment includes: a hot winding treatment and a cold pressing treatment, the hot winding treatment includes causing the glue dots of the plurality of group of glue dots to be in the molten state and to form the adhesive layers, and fixing the separating film to at least one of the positive electrode sheet and the negative electrode sheet, and the cold pressing treatment includes bonding the positive electrode sheet, the negative electrode sheet, and the separating film.

In some embodiments, the method further includes: before performing the winding treatment on the stacked structure, performing a heat treatment on the film layer, wherein the heat treatment includes causing the glue dots of the plurality of groups of glue dots to be in the molten state and pre-fixing the separating film to at least one of the positive electrode sheet and the negative electrode sheet.

In some embodiments, during performing of the winding treatment on the stacked structure, the method further includes: performing a heat treatment on the film layer, wherein the heat treatment includes causing the glue dots of the plurality of groups of glue dots to be in the molten state and to form the adhesive layers.

According to some embodiments, an energy storage cell is provided and includes a positive electrode sheet, a negative electrode sheet, a separating film positioned between the positive electrode sheet and the negative electrode sheet, and a plurality of adhesive layers provided between the positive electrode sheet and the separating film or between the negative electrode sheet and the separating film. The positive electrode sheet and the separating film are fixed by the plurality of adhesive layers and/or the negative electrode sheet and the separating film are fixed by the plurality of adhesive layers. A distribution density of the plurality of adhesive layers decreases in a winding direction from an inner ring toward an outer ring of the energy storage cell.

### BRIEF DESCRIPTION OF THE DRAWINGS

One or more embodiments are illustrated by the figures in the accompanying drawings corresponding thereto, and these illustrative descriptions are not intended to limit the embodiments, and unless otherwise stated, the figures in the accompanying drawings are not intended to limit the scale. In order to more clearly explain the embodiments of the present disclosure or the technical solutions in the conventional technology, the drawings that need to be used in the embodiments will be briefly introduced below, and it is obvious that the drawings in the following description are only some embodiments of the present disclosure, and other drawings can be obtained from these drawings without making creative efforts for those skilled in the art.

FIG. 1 is a flow chart of a method for preparing an energy storage cell according to an embodiment of the present disclosure.

FIG. 2 is a preparation flow chart in which a film layer is a positive electrode sheet or a negative electrode sheet in a method for preparing an energy storage cell according to an embodiment of the present disclosure.

FIG. 3 is a preparation flow chart in which a film layer is a separating film in a method for preparing the energy storage cell according to an embodiment of the present disclosure.

FIG. 4A is a top view of a film layer corresponding to an operation of providing a film layer in a method for preparing an energy storage cell according to an embodiment of the present disclosure.

FIG. 4B is a top view of a film layer having glue dots according to an embodiment of the present disclosure.

FIG. 5 is a first top view of a film layer corresponding to an operation of performing dispensing treatment in a method for preparing an energy storage cell according to an embodiment of the present disclosure.

FIG. 6 is a second top view of a film layer corresponding to an operation of performing dispensing treatment in a method for preparing an energy storage cell according to an embodiment of the present disclosure.

FIG. 7 is a third top view of a film layer corresponding to an operation of performing dispensing treatment in a method for preparing an energy storage cell according to an embodiment of the present disclosure.

FIG. 8 is a cross-sectional view of an energy storage cell corresponding to an operation of performing a winding treatment in a method for preparing an energy storage cell according to an embodiment of the present disclosure.

### DETAILED DESCRIPTION OF THE EMBODIMENTS

In view of the above, a yield rate of current energy storage cells is poor and the preparation cost of the energy storage cells is high.

Analysis found that one of reasons for the poor yield rate and high preparation cost of the energy storage cells is that a main function of conventional separating films (separators) is to separate cathode materials (a negative electrode represented by the negative electrode sheet) and anode materials (a positive electrode represented by the positive electrode sheet) of the battery to prevent two electrodes of different polarities from being in contact with each other to avoid short circuits. In addition, during electrochemical reactions, necessary electrolyte needs to be kept to form a channel for ion transport.

In order to realize fixing between the separating film and the positive electrode sheet and the separating film and the negative electrode sheet, a glue-coating layer is generally provided on a base film where the separating film is located to form a glue-coating separating film. The glue-coating layer has adhesive properties and is attached to a surface of the electrode sheet (positive electrode sheet or negative electrode sheet) after hot pressing, thereby increasing shrinkage resistance and flatness, allowing the electrode sheet and the separating film to fit closely, shortening the lithium-ion transport path, and reducing interface impedance between the electrode sheets. The hot-pressed glue-coating separating film, e.g., the glue-coating layer of the glue-coating separating film, is solidified after cooling, which may improve the mechanical properties of the winding core composed of the positive electrode sheet, the separating film, and the negative electrode sheet, and facilitating assembly.

However, the usage of the glue-coating separating film also brings other problems. The separating film is completely adhered to the surface of the electrode sheet. Since a surface of the glue-coating separating film is completely adhered to the surface of the electrode sheet, which increases the amount of the glue-coating layer and increases the cost of the separating film. In addition, due to different radians of the bending regions of an inner ring and an outer ring of the winding core, the stress of the inner ring is large, which may easily cause delamination, and thus, may make the separating film of the inner ring easily wrinkles.

Embodiments of the present disclosure provide a method for preparing an energy storage cell, where a plurality of groups of glue dots and non-uniformly distributed glue dots are formed on a film layer, thereby reducing the preparation cost of glue and improving the problem that an inner ring is easily wrinkled.

In the description of the embodiments of the present disclosure, the technical terms “first”, “second” and the like are only used to distinguish different objects, and could not be understood to indicate or imply relative importance or implicitly indicate the number, specific order, or primary-secondary relationship of the indicated technical features. In the description of the embodiments of the present disclosure, “a plurality” means two or more unless otherwise explicitly and specifically defined.

Reference herein to an “embodiment” means that a particular feature, structure, or characteristic described in connection with the embodiment may be included in at least one embodiment of the present disclosure. The appearance of the phrase in various places in the specification does not necessarily refer to the same embodiment, nor is it an independent or alternative embodiment that is mutually exclusive from other embodiments. It is explicitly and implicitly understood by those skilled in the art that the embodiments described herein may be combined with other embodiments.

In the description of the embodiment of the present disclosure, the term “and/or” is merely an association relationship describing an association object, indicating that there may be three relationships, e.g., A and/or B, which may indicate that there is A, there are both A and B, and there is B. In addition, the character “/” herein generally indicates that the related objects before and after are in an “or” relationship.

In the description of the embodiments of the present disclosure, the term “a plurality/multiple” refers to two or more (including two), similarly, “a plurality of groups” refers to two or more groups (including two groups), and “a plurality of pieces” refers to two or more pieces (including two pieces).

In the description of the embodiments of the present disclosure, orientation or positional relationships indicated by the technical terms such as “center”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, “axial”, “radial”, “circumferential”, and the like are based on the orientation or positional relationships shown in the drawings. The above technical terms are merely used to facilitate the description and simplify the description of the embodiments of the present disclosure, and do not indicate or imply that the referred device or element must have a specific orientation, be constructed and operated in a specific orientation, and therefore could not be understood as a limitation of the embodiments of the present disclosure.

In the description of the embodiments of the present disclosure, unless otherwise explicitly specified and limited, technical terms, such as “mounted”, “coupling”, “connected” and “fixed” should be understood in a broad sense, for example, the technical terms may indicate a fixed connection, a detachable connection, or an integrated connection. Alternatively, the technical terms may indicate a mechanical connection or an electrical connection. Alternatively, the technical terms may indicate a direct connection, or indirect connection through an intermediate medium, or the technical terms may indicate the internal communication of two elements or the interaction between two elements. For those skilled in the art, the specific meanings of the above terms in the embodiments of the present disclosure can be understood according to specific circumstances.

In the drawings corresponding to the embodiments of the present disclosure, the thickness and area of the layers are enlarged for better understanding and convenience of description. When describing a component (such as a layer, film, region, or substrate) on another component, the component may be located “directly” on a surface of the other component, or there may be a third component between the two components. On the contrary, when it is described that one component is on a surface of another component or that one surface of the component is formed or provided with another component, it is indicated that there is no third component between the two components. Furthermore, when one component is described as “substantially” formed on another component, it may mean that the component is not formed on the entire surface (or front surface) of the other component, nor is it formed on a portion of the edge of the entire surface.

In the description of embodiments of the present disclosure, when a component “includes/comprises” another component, other components are not excluded unless otherwise specified, and other components may be further included. Furthermore, when a component such as a layer, film, region, or plate is referred to as “on/located” on another component, it may be “directly” on the other component (i.e. located between the surface of the other component, and there are no other components) or may have another component present therebetween. Further, when a layer, film, region, plate, etc. is “directly located” on another component, or when a layer, film, region, plate, etc. is located on the surface of the other component, it may mean that no other component is located therebetween.

The terminology used in the description of the various described embodiments herein is for the purpose of describing particular embodiments only and is not intended to be limiting. As used in the description of the various embodiments described and in the appended claims, “the portion” is also intended to include the plural form unless the context clearly dictates otherwise. The component includes a member such as a layer, a film, a region, or a plate, thereby improving the yield rate of the cell.

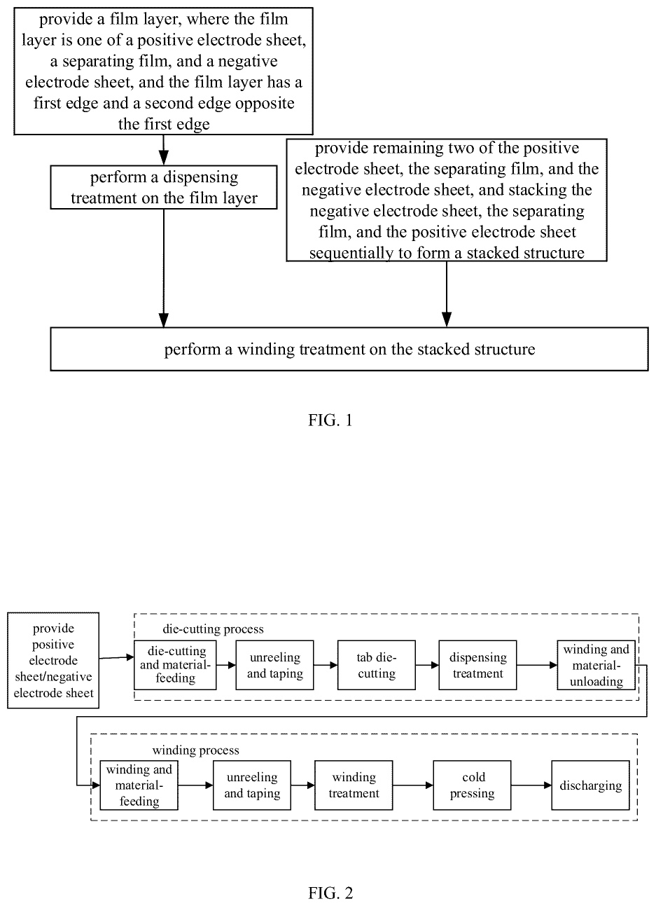

FIG. 1 is a flow chart of a method for preparing an energy storage cell according to an embodiment of the present disclosure.

According to one aspect, embodiments of the present disclosure provide a method for preparing an energy storage cell. Referring to FIG. 1, the method includes the following. A film layer is provided, where the film layer is one of a positive electrode sheet, a separating film, or a negative electrode sheet. A dispensing treatment is performed on the film layer. The remaining two of the positive electrode sheet, the separating film, and the negative electrode sheet are provided. A winding treatment is performed on the positive electrode sheet, the negative electrode sheet, and the separating film.

It shall be understood that before performing the winding treatment, the negative electrode sheet, the separating film, and the positive electrode sheet are stacked sequentially to form a stacked structure, where the separating film is disposed between the positive electrode sheet and the negative electrode sheet in the stacked structure. In addition, there is no restriction on whether edges of the negative electrode sheet, the separating film, and the positive electrode sheet in the stacked structure are aligned with each other before they are wound up. In other words, before the winding treatment, the edges of the negative electrode sheet, the separating film, and the positive electrode sheet in the stacked structure are or are not aligned with each other.

The film layer has a first edge and a second edge opposite the first edge. The dispensing treatment is performed on the film layer so that a surface of the film layer has a plurality of groups of glue dots arranged in a first direction from the first edge to the second edge. A distribution density of glue dots in the plurality of groups of glue dots decreases in a direction from the second edge toward the first edge. The winding treatment is performed from the second edge toward the first edge. The separating film is positioned between the positive electrode sheet and the negative electrode sheet. The winding treatment is used to at least make the glue dots of the plurality of groups of glue dots be in a molten state and form adhesive layers, so that the positive electrode sheet and the separating film are fixed and/or the separating film and the negative electrode sheet are fixed.

The distribution density of glue dots in the plurality of groups of glue dots decreasing in the direction from the second edge toward the first edge can be understood as follows. The plurality of groups of glue dots includes a first group of glue dots and a second group of glue dots, the first group of glue dots is adjacent to the second group of glue dots and closer to the first edge, and thus, the distribution density of glue dots in the first group of glue dots is less than the distribution density of glue dots in the second group of glue dots.

In the method for preparing the energy storage cell provided in the present disclosure, the dispensing treatment is performed on one of the positive electrode sheet, the separating film, or the negative electrode sheet, and the plurality of groups of glue dots are arranged in a specific manner to alleviate or offset the stress problem caused by the bending region of the winding core, thereby avoiding subsequent wrinkles at an interface between the positive electrode sheet and the separating film and an interface between the separating film and the negative electrode sheet caused by the wrinkles of the separating film, so as to improve the interface effect. Based on uneven arrangement, for any two groups A and B of glue dots of the plurality of groups of glue dots, if the group A is closer to the first edge than the group B, the distribution density of glue dots of the group A is smaller than that in the group B, that is, the group B is closer to the second edge than the group A, the distribution density of glue dots of the group B is greater than that in the group A. In this way, the glue dots closer to the outer ring of the winding core has a small distribution density, and the glue dots closer to the inner ring of the winding core has a larger distribution density, which can ensure an adhesive force of a joint between a portion of the separating film closer to the inner ring and the positive electrode sheet and the portion of the separating film closer to the inner ring and the negative electrode sheet to be larger, so as to resist the stress caused by the bending. Therefore, the positive electrode sheet and the separating film, and the separating film and the negative electrode sheet more closely bonded, thereby improving the problem that the inner ring of the winding core at the full charging interface easy to wrinkle, and reducing the dosage of glue and reducing the preparation cost.

According to the appearance classification, the prepared energy storage cells may include square cells, round cells, or soft-packed cells. According to capacity classification, the energy storage cells may include cells of 50 Ah, 100 Ah, 150 Ah, 200 Ah, 280 Ah, 306 Ah, 314 Ah, 500+Ah, 800+Ah, and 1000+Ah. According to the chemical composition and working principle of cells, the energy storage cells may include cells of lithium-ion batteries, cells of lead-acid batteries, cells of sodium-ion batteries, or cells of nickel-metal hydride batteries. In the embodiments of the present disclosure, a method for preparing a cell of a lithium-ion battery is taken as an example. For those skilled in the art, the lithium ions in the positive electrode sheet, the negative electrode sheet, and the electrolyte can be replaced with corresponding metal ions according to actual needs. For example, in a sodium-ion battery, a lithium transition metal oxide of the subsequent positive electrode active substance can be replaced with any of layered metal oxides (such as NaFcO₂), polyanionic compounds (NaFePO₄), and Prussian blue compound systems (such as NaMnFe (CN)₆-zH₂O). The electrolyte can be replaced with any of an organic liquid electrolyte, a solid-state composite electrolyte, or a solid-state electrolyte.

Hereinafter, embodiments of the present disclosure will be described in detail with reference to the accompanying drawings. However, one of ordinary skill in the art will appreciate that many technical details have been set forth in various embodiments of the present disclosure in order to better understand the present disclosure by the reader. However, even without these technical details and various changes and modifications based on the following embodiments, the technical solutions claimed in the present disclosure can be realized.

In some embodiments, the positive electrode sheet and the negative electrode sheet serve as an anode (positive electrode/terminal) and a cathode (negative electrode) of the energy storage cell, respectively. The anode is a plate/electrode in the energy storage cell at which an oxidation reaction occurs, and the cathode is a plate/electrode in the energy storage cell at which a reduction reaction occurs. The positive electrode and the negative electrode are isolated and connected together through an electrolyte, and the positive electrode and the negative electrode serve as an electrochemical reaction region in the energy storage cell.

The positive electrode sheet includes a positive electrode current collector and a positive electrode active material layer, and the positive electrode active material layer is located on the positive electrode current collector. A part of the positive electrode current collector is cut into the shape of a tab and serves as a positive electrode tab.

The positive electrode current collector may be an aluminum foil, and the aluminum foil is cheaper than a copper foil. A dense oxide thin film is formed on a surface of aluminum foil. The oxide thin film is relatively thin, which can improve the corrosion resistance of the aluminum foil, and electrons can achieve conductance through tunneling effect.

In some embodiments, the positive electrode current collector may be a composite current collector. The composite current collector includes three layers of stacked upper, middle, and lower layers, where the middle layer is organic, the upper layer is a copper-plated layer, and the lower layer is an aluminum-plated layer. The organic is polyethylene terephthalate (PET), polypropylene (PP), polyimide (PI), or the like.

In some embodiments, the positive electrode current collector may also be a carbon-based current collector, that is, there is a conductive carbon layer on the aluminum foil. The conductive carbon layer can be used as a protective layer to effectively protect the current collector to prevent corrosion of the metal current collector, thereby improving the life of the current collector. In addition, the conductive carbon layer has a low resistivity so that no excessive electrical losses are generated.

The carbon-based current collector may be configured as that the conductive carbon layers are provided at both upper and lower surfaces of the aluminum foil, or that a part of the surface of the aluminum foil is covered with the conductive carbon layer.

The positive electrode tab is a metal conductor that leads the positive electrode of the energy storage cell from the cell. The positive electrode tab is a contact point between the positive electrode sheet/plate and an external contact member when the cell is charged and discharged. The external contact member may be a pole post.

The negative electrode sheet/plate includes a negative electrode current collector and a negative electrode active material layer. The negative electrode active material layer is located on the negative electrode current collector, and a part of the negative electrode current collector is cut into the shape of a tab and serves as a negative electrode tab.

In some embodiments, the negative electrode current collector may be a copper foil, the copper foil has a low conductivity and may have a high electron transport capacity. The copper foil has a weak lithium intercalation ability and captures less lithium ions, thereby effectively reducing the loss of lithium ions. In other embodiments, the negative electrode current collector may also be a copper foam current collector, a copper mesh current collector, or a three-dimensional nano-copper array current collector.

In some embodiments, the negative electrode active material layer may include a negative electrode active material, a conductive agent, and an adhesive. The negative electrode active material may include two categories: a carbon-based material and a non-carbon-based material. The carbon-based material include graphite materials (natural graphite, artificial graphite, and carbonaceous mesophase spheres) and other carbon materials (hard carbon, soft carbon, and graphene). The non-carbon-based material may include titanium-based materials, silicon-based materials, tin-based materials, nitride, metal lithium, and the like.

The conductive agent of the negative electrode active material layer is similar to a conductive agent of the positive electrode active material layer, and the adhesive of the negative electrode active material layer is similar to an adhesive of the positive electrode active material layer, which may mainly include oil-system polyvinylidene difluoride (PVDF), water soluble carboxymethyl cellulose (CMC), polyvinyl alcohol (PVA), sodium alginate, etc., which will not be repeated herein.

The negative electrode tab is a metal conductor that leads the negative electrode of the energy storage cell from the cell. The negative electrode tab is a contact point between the negative electrode sheet/plate and an external contact member when the cell is charged and discharged. The external contact member may be a pole post (or pole).

The separating film is used to avoid short circuit problems caused by physical contact between the positive electrode sheet and the negative electrode sheet, and to allow ions to conduct through the electrolyte and to hinder transport of electron, so that ions and electrons form a loop during charging and discharging of the battery.

The separating film may be any of a microporous membrane, a modified microporous membrane, a nonwoven membrane, and a composite membrane. The microporous membrane is a separating film with a pore diameter in a micron range, and mainly includes a polyolefin microporous membrane and other polymer microporous membranes. The modified microporous membrane is a separating film obtained by performing a modifying treatment on the microporous membrane. Common methods for the modifying treatment include surface treatment, chemical grafting, surface coating, and the like. The non-woven membrane has a small fiber diameter and typically exhibits a higher porosity than other types of membranes. The composite membrane is prepared by coating or filling inorganic materials in the microporous membrane or the non-woven membrane, and have higher thermal stability and electrolyte wettability than other kinds of membranes.

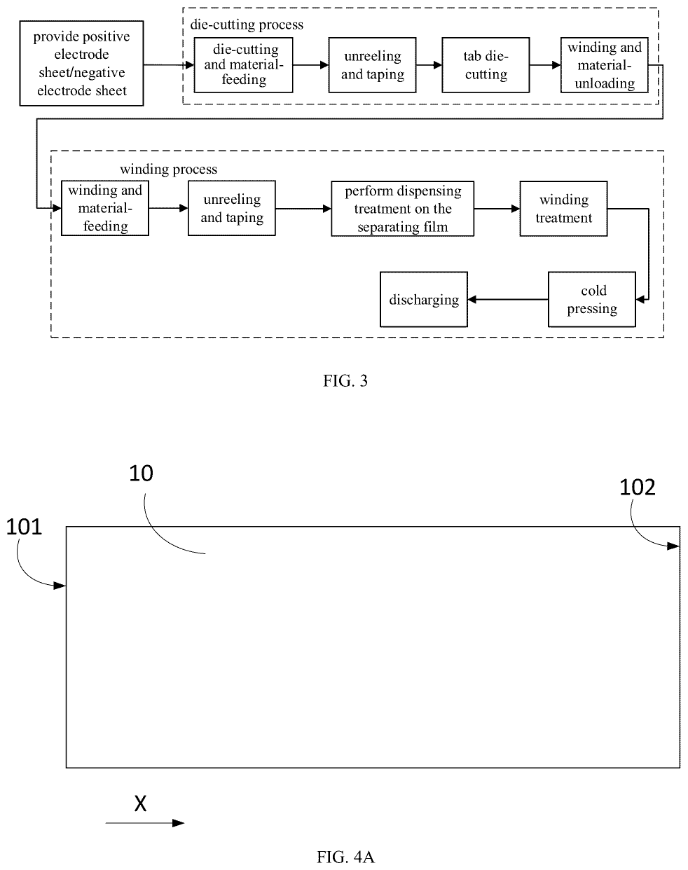

FIG. 2 is a preparation flow chart in which a film layer is a positive electrode sheet or a negative electrode sheet in a method for preparing an energy storage cell according to an embodiment of the present disclosure. FIG. 3 is a preparation flow chart in which a film layer is a separating film in a method for preparing the energy storage cell according to an embodiment of the present disclosure.

Referring to FIG. 2, the film layer is the positive electrode sheet or the negative electrode sheet, and before performing the dispensing treatment, the following may be further conducted. Tab die-cutting is performed on the positive electrode sheet or the negative electrode sheet to form tabs adjacent to the first edge. In this way, the dispensing treatment being performed on the positive electrode sheet/negative electrode sheet can avoid the problem of large-area wrinkles around the region for gluing caused by the soft texture of the separating film, and can even avoid the formation of “dead wrinkles” in the subsequent cold pressing process. In other words, the dispensing treatment being performed on the positive electrode sheet/negative electrode sheet can effectively avoid the wrinkle problem caused by the dispensing process of the separating film, thereby avoiding the problem of wrinkles at an interface between the positive electrode sheet and the separating film and an interface between the separating film and the negative electrode sheet caused by the subsequent wrinkles of the separating film, so as to improve the interface effect. The tabs may be positive electrode tabs of the positive electrode sheet or negative electrode tabs of the negative electrode sheet.

In some embodiments, for conventional positive electrode base sheets and negative electrode base sheets, the conventional positive electrode base sheets or negative electrode base sheets are cut into corresponding positive electrode sheets/negative electrode sheets after the active material layer is coated, and then a die-cutting process is performed on the formed positive electrode sheets and negative electrode sheets based on die-cutting parameters. The die-cutting process includes operations of die-cutting and material-feeding, unwinding/unreeling and taping, tab die-cutting, and winding and material-unloading. In the method provided in the embodiment in the present disclosure, the dispensing treatment is performed after the tab die-cutting. That is, the first edge and the second edge are distinguished based on the positions of the tabs, and then the inner ring and the outer ring in the subsequent winding treatment are distinguished based on the first edge and the second edge, which is more convenient and efficient compared with other distinguishing processes and distinguishing methods. In addition, the improvement being performed based on the original process may not have a large impact on the original equipment and operations, thereby reducing the preparation cost.

Referring to FIG. 3, the film layer is the separating film, and performing the dispensing treatment, forming the positive electrode sheet and the negative electrode sheet, and performing the winding treatment are achieved as follows. The separating film, the positive electrode sheet, and the negative electrode sheet are provided. Feeding of the separating film, the positive electrode sheet, and the negative electrode sheet is sequentially performed. The dispensing treatment is performed on the separating film. The winding treatment is performed on the positive electrode sheet, the negative electrode sheet, and the separating film.

In some embodiments, for the conventional positive electrode base sheets and negative electrode base sheets, the conventional positive electrode base sheets or negative electrode base sheets are cut into corresponding positive electrode sheets/negative electrode sheets after the active material layer is coated, and then a die-cutting process is performed on the formed positive electrode sheets and negative electrode sheets based on die-cutting parameters and finally a winding process is performed. The die-cutting process includes operations of die-cutting and material-feeding, unwinding/unreeling and taping, tab die-cutting, and winding and material-unloading. The winding process includes the operations of winding and material-feeding, unwinding/unreeling and taping/moving, winding treatment, and discharging, and the like. In the method provided in the embodiments in the present disclosure, the dispensing treatment is performed on the separating film after unreeling and taping. That is, in this case, the separating film, the positive electrode sheet, and the negative electrode sheet have been aligned. Therefore, the first edge and the second edge can be distinguished based on the positions of the tabs, and then the inner ring and the outer ring in the subsequent winding treatment can be distinguished based on the first edge and the second edge, which is more convenient and efficient compared with other distinguishing processes and distinguishing methods.

Hereinafter, the distribution arrangement in the dispensing treatment provided in the embodiments of the present disclosure will be described with reference to the related drawings.

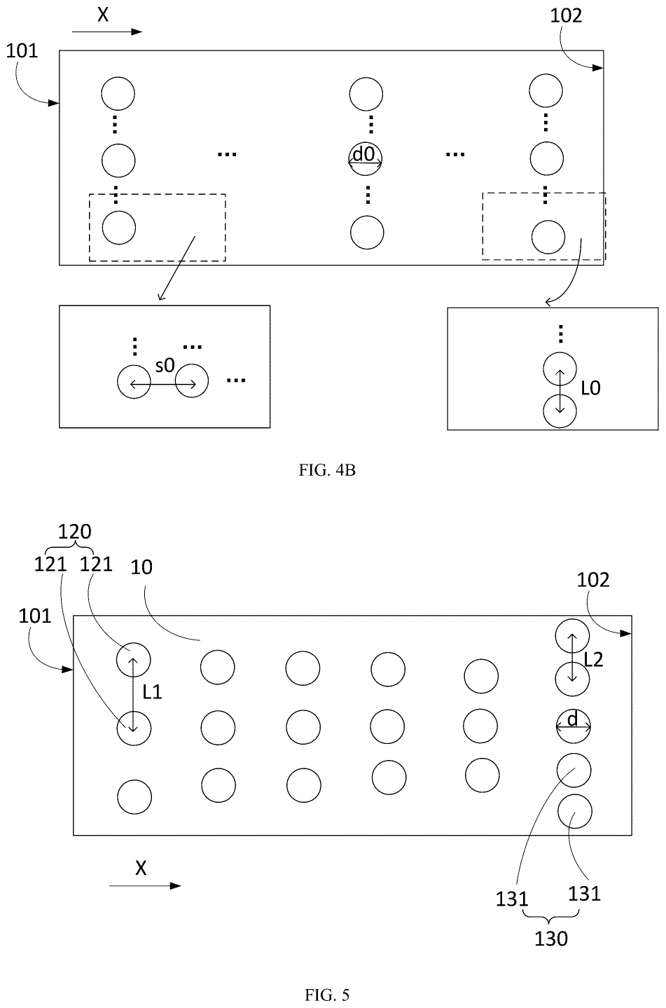

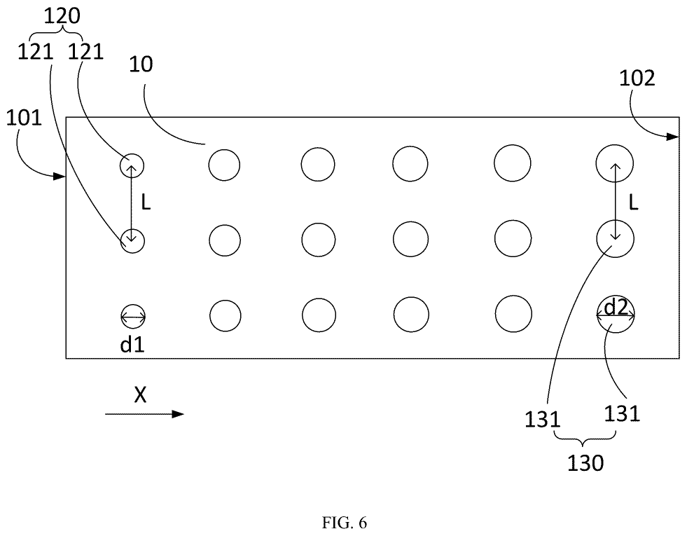

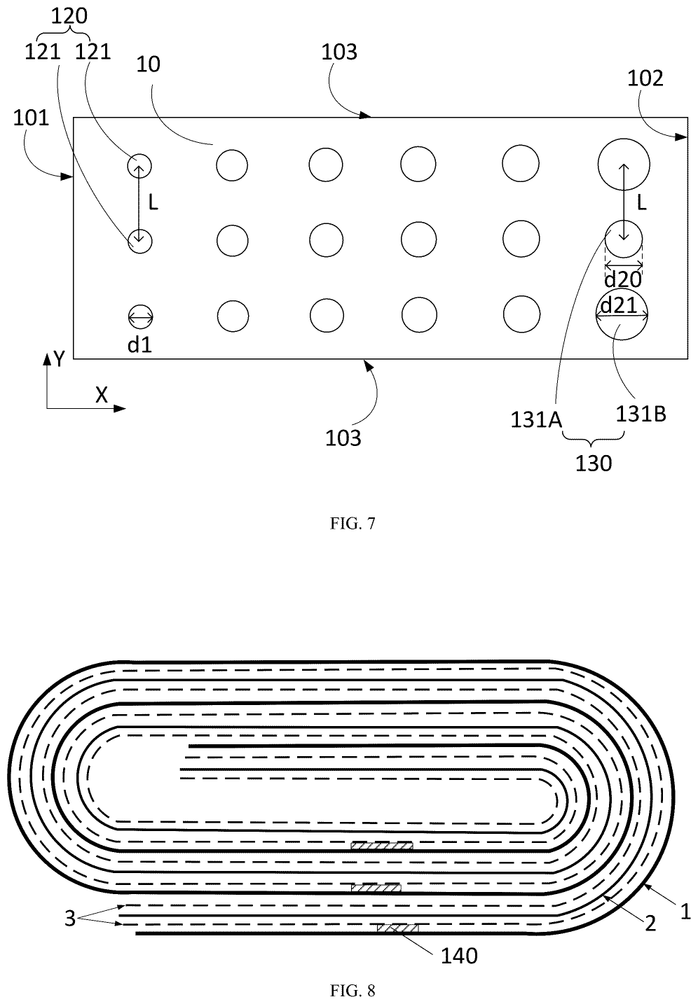

FIG. 4A is a top view of a film layer corresponding to an operation of providing a film layer in a method for preparing an energy storage cell according to an embodiment of the present disclosure. FIG. 4B is a top view of a film layer having glue dots according to an embodiment of the present disclosure. FIG. 5 is a first top view of a film layer corresponding to an operation of performing dispensing treatment in a method for preparing an energy storage cell according to an embodiment of the present disclosure. FIG. 6 is a second top view of a film layer corresponding to an operation of performing dispensing treatment in a method for preparing an energy storage cell according to an embodiment of the present disclosure. FIG. 7 is a third top view of a film layer corresponding to an operation of performing dispensing treatment in a method for preparing an energy storage cell according to an embodiment of the present disclosure.

Referring to FIG. 4A, the method includes providing a film layer 10, where the film layer 10 is one of a positive electrode sheet, a separating film, or a negative electrode sheet, and the film layer 10 has a first edge 101 and a second edge 102 opposite the first edge 101.

In some embodiments, if the film layer 10 is the positive electrode sheet or the negative electrode sheet, the film layer 10 has tabs at an end portion close to the first edge 101. That is, for the positive electrode sheet/negative electrode sheet after being subjected to tab die-cutting, the first edge 101 and the second edge 102 are distinguished based on positions of the tabs.

Referring to FIG. 5 or FIG. 6, the method includes: performing a dispensing treatment on the film layer 10, so that a surface of the film layer 10 has a plurality of groups of glue dots arranged in a first direction X from the first edge 101 to the second edge 102. A distribution density of glue dots in the plurality of groups of glue dots gradually decreases in a direction from the second edge 102 toward the first edge 101. Each group of glue dots of the plurality of groups of glue dots includes a plurality of glue dots arranged at intervals in a second direction.

It shall be understood that the second direction intersects with the first direction, and the second direction is not necessarily perpendicular to the first direction.

In some embodiments, as illustrated FIG. 4B, a size of each glue dot is defined as do, where do is in a range of 0.1 mm to 0.5 mm. The size of the glue dot may be in a range of 0.1 mm to 0.2 mm, 0.2 mm to 0.3 mm, 0.3 mm to 0.4 mm, or 0.4 mm to 0.5 mm. The size of the glue dots may be 0.1 mm, 0.18 mm, 0.23 mm, 0.38 mm, 0.46 mm, or 0.5 mm. The above range of the size of the glue dots can make the distribution density of glue dots in the groups of glue dots easier to plan, thereby reducing the difficulty of preparing the glue dots. In addition, the range of the size of the glue dots can also avoid the large area of the glue dots, and then the stress caused by subsequent curing may cause adverse effects on the film layer, thereby improving the yield of the energy storage cell.

It shall be understood that there is no restriction the size and shape of the glue dot. For example, when the glue has a circular shape, the size of the glue dot may refer to the diameter of the glue dot. Alternatively, when the glue dot has a square shape, the size of the glue dot may refer to a length of the short edge or the long edge, or the length of the diagonal.

In some embodiments, as illustrated FIG. 4B, for each group of glue dots, a spacing between each two adjacent glue dots is defined as L0, and L0 is in a range of 1d0 to 2d0. L0 may be in a range of 1d0 to 1.2 d0, 1.2 d0 to 1.5 d0, 1.5 d0 to 1.8 d0, or 1.8 d0 to 2d0. L0 may be 1d0, 1.3 d0, 1.6 d0, or 1.9 d0.

In some embodiments, as illustrated FIG. 4B, a spacing between two adjacent groups of glue dots is defined as S0, and S0 is in a range of 1.2 d0 to 2.5 d0. S0 may be in a range of 1.2 d0 to 1.5 d0, 1.5 d0 to 1.8 d0, 1.8 d0 to 2.1 d0, or 2.1 d0 to 2.5 d0. S0 may be 1.3 d0, 1.6 d0, 1.9 d0, 2.3 d0, or 2.5 d0.

In some embodiments, a total area of an orthographic projection of the glue dots in the plurality of groups of glue dots on the film layer 10 accounts for 10% to 14% of a surface area of the film layer 10. For example, the total area of the orthographic projection of the glue dots in the plurality of groups of glue dots on the film layer 10 accounts for 10%, 11%, 12%, 13%, or 14% of the surface area of the film layer 10. In this way, a ratio of the total area of the orthographic projection of the glue dots of the plurality of groups of glue dots on the film layer 10 to the surface area of the film layer 10 can be understood as a region where glue dots are formed in one surface of the film layer. If the ratio of the total area of the glue dots to the surface area of the film layer is within the above range, the content of glue dots is more appropriate, so as to realize the mutual bonding between the positive electrode sheet and the separating film and the mutual bonding between the negative electrode sheet and the separating film, and avoid the mutual separation of the two. In addition, the content of glue is also more appropriate, thereby reducing the preparation cost of glue and avoiding the problem of glue overflow.

In some embodiments, a middle position of the film layer in the first direction is taken as a boundary line, a region from the boundary line to the first edge is defined as a sparse region, and a region from the boundary line to the second edge is a dense region. For the dense region, the size of each glue dot is defined as D1, D1 is in a range of 1d0 to 1.2 d0, the spacing between two adjacent groups of glue dots is defined as S1, S1 equals 0.9 S0, the spacing between two adjacent glue dots of each group of glue spots is defined as C1, C1 equals 0.9 L0, and a ratio of a total area of the orthographic projection of the glue dots in the dense region on the film layer to a surface area of part of the film layer in the dense region is in a range of 12% to 16%. For the sparse region, the size of each glue dot is defined as D2, D2 is in a range of 0.8 d0 to 1d0, the spacing between two adjacent groups of glue dots is defined as S2, S2 equals 1.1 SO, the spacing between two adjacent glue dots of each group of glue dots is defined as C2, C2 equals 1.3 L0, and a ratio of a total area of the orthographic projection of the glue dots in the sparse region on the film layer to a surface area of part of the film layer in the sparse region is in a range of 7% to 11%.

It is to be noted that the spacing/distance refers to a straight-line distance between a center of the glue dot and a center of an adjacent glue dot.

In some embodiments, the glue dots of each group of glue dots are sequentially formed by interpolation method. The interpolation method may adopt a linear interpolation model or a Lagrange interpolation model.

In some embodiments, referring to FIG. 5, the plurality of groups of glue dots include a first group of glue dots 120 close to the first edge 101 and a second group of glue dots 130 close to the second edge 102. A first spacing L1 between each adjacent first glue dots 121 in the first group of glue dots 120 is greater than a second spacing L2 between adjacent second glue dots 131 in the second group of glue dots 130. The different spacings of glue dots in the groups of glue dots in different positions also make the distribution density of glue dots different in the unit area. That is, the distribution density of the first glue dots 121 in the first group of glue dots 120 close to the first edge 101 is smaller than that of the second glue dots 131 in the second group of glue dots 130 close to the second edge 102. In other words, the distribution density of the glue dots close to the inner ring of the winding core is larger, thus having great adhesive force to avoid and resist the stress caused by the winding treatment, thereby avoiding delamination between the separating film in the inner ring and the positive electrode sheet and the separating film and the negative electrode sheet, and avoiding wrinkles of the separating film.

In addition, if the spacing between the glue dots in the outer ring is large, the region where the outer ring is located can be used as a gas discharging channel. That is, the gas released by the separating film, the positive electrode sheet, and the negative electrode sheet in the outer ring due to the electrolyte can be discharged through the channel formed by two glue dots, thereby avoiding the problem of wrinkles of the separating film caused by bubbles formed by the gas.

In some embodiments, a ratio of the first spacing L1 to the second spacing L2 is in a range of 1.03 to 1.3. The ratio of the first spacing L1 to the second spacing L2 may be 1.03, 1.1, 1.2, or 2. When the ratio of the spacing between the glue dots of the inner ring and the spacing between the glue dots of the outer ring is within this range, the relevant parameters of the dispensing process can be controlled, so that the preparation cost can be reduced, the separating film and the positive electrode sheet can be guaranteed to be better bonded to improve the corresponding problem.

In some embodiments, referring to FIG. 6, the plurality of groups of glue dots include a first group of glue dots 120 close to the first edge 101 and a second group of glue dots 130 close to the second edge 102. A size d1 of each first glue dot 121 in the first group of glue dots 120 is smaller than a size d2 of any second glue dot 131 of the second group of glue dots 130. In this way, a distribution density of first glue dots 121 of the first group of glue dots 120 close to the first edge 101 is smaller than that of second glue dots 131 of the second group of glue dots 130 close to the second edge 102. That is, the distribution density of the glue dots close to the inner ring of the core is larger, and thus has a great adhesive force to avoid and resist the stress caused by the winding treatment, so that detachment between the separating film in the inner ring and the positive electrode sheet or between the separating film and the negative electrode sheet can be avoided, and thus wrinkles of the separating film can be avoided.

The glue dots shown in FIG. 5 may have a same size, e.g., the size d. In some embodiments, the glue dots may have different sizes, but it needs to be satisfied that the distribution density of the group of glue dots close to the first edge 101 is smaller than the distribution density of the group of glue dots close to the second edge 102. For example, the size of each first glue dot 121 is smaller than the size of any second glue dot 131. Similarly, for each group of glue dots, the spacing between adjacent glue dots of each group of glue dots shown in FIG. 6 may be the same, e.g., the spacing L. In some embodiments, the spacing between the adjacent glue dots may also be different, but it needs to be satisfied that the distribution density of the glue dots of the groups of glue dots close to the first edge 101 is smaller than the distribution density of the glue dots of the groups of glue dots close to the second edge 102. For example, the spacing between the glue dots in the first group of glue dots 120 is larger than the spacing between glue dots of the second group of glue dots 130.

It shall be noted that although in FIGS. 5 to 7, the shape of the glue dots is illustrated as a circular shape, there is no restriction on the shape and size of the glue dots, and for those skilled in the art, the shape and size of the glue dots can be determined according to actual needs, as long as the distribution density of the glue dots close to the first edge 101 is smaller than the distribution density of the glue dots close to the second edge 102.

In some embodiments, the film layer 10 further has two opposing third edges 103 in the second direction Y. Each of the two third edges 103 is connected between the first edge 101 and the second edge 102. During performing of the dispensing treatment on the film layer 10, the distribution density of the glue dots in each of the plurality of groups of glue dots close to the third edge 103 is increased in the direction from a center of the film layer in the second direction toward a corresponding third edge. The high density of glue dots on both sides of the film layer in the second direction ensures a closer fit between the part of the separating film at the edge and the positive electrode sheet/negative electrode sheet, and avoid interlayer dislocation damage caused by the friction on the side during the transfer of the subsequent core, and avoid the effect of airflow and electrolyte on the core in the liquefied injection process, improve the problem of brown spots on the bottom of the head of the core of the fully charged interface, reduce the dosage of glue, and reduce the preparation cost.

In some embodiments, the spacing between each adjacent glue dots decreases in the direction from the center of the film layer 10 in the second direction Y toward a corresponding third edge of the two third edges 103. For example, for each group of the glue dots including a first glue dot, a second glue dot, and a third glue dot, the first glue dot is closer to the third edge than the second glue dot, and the second glue dot is closer to the third edge than the third glue dot, a spacing between the first glue dot and the second glue dot is less than a spacing between the second glue dot and the third glue dot.

Alternatively, with reference to FIG. 7, in the direction from the center of the film layer 10 in the second direction Y toward a corresponding third edge of the two third edges 103, the sizes of the glue dots increase. For example, the glue dot 131B is closer to the third edge 103 than the glue dot 131A, a size d21 of the glue dot 131B is larger than a size d20 of the glue dot 131A. Both the manners in which the spacings between adjacent glue dots decrease and the sizes of the glue dots increase can make the distribution density appear to increase in the direction from the center of the film layer 10 in the second direction Y toward a corresponding third edge of the two third edges 103, so that the content of glue close to the edge in the second direction is larger, and thus the edge of the separating film and the electrode sheet can be more closely adhered to each other.

It is to be noted that FIG. 7 only shows a trend that the sizes of the second glue dots in the second group of glue dots 130 increase in the direction from the center of the film layer 10 in the second direction Y toward a corresponding third edge of the two third edges 103. It shall be understood that the first glue dots in the first group of glue dots 120 and glue dots located in the other groups of glue dots may also show this trend, which is not limited in the embodiment of the present disclosure.

In some embodiments, before the winding treatment is performed on the positive electrode sheet, the negative electrode sheet, and the separating film, the film layer 10 is subjected to a heat treatment, where the heat treatment is configured at least to cause the glue dots of the plurality of groups of glue dots to be into a molten state and pre-fix the positive electrode sheet and the separating film and/or pre-fix the negative electrode sheet and the separating film. In this way, the glue dots located on the film layer may be activated to become sticky after heating. During pre-fixing, the subsequently formed cells are preheated and pressed, and the preheated and pressed glue is activated to become sticky, so that the positive electrode sheet/negative electrode sheet and the separating film are bonded and fixed.

In some embodiments, during performing of the winding treatment on the positive electrode sheet, the negative electrode sheet, and the separating film, the following operations can be further performed. A heat treatment is performed on the film layer 10, and the heat treatment includes causing the glue dots of the plurality of groups of glue dots to be in a molten state and forming adhesive layers. Since heating and winding are performed concurrently (i.e., hot rolling), the adhesion of the glue dots on the film layer can be activated, so that the subsequent cold pressing steps and molding effects of the winding core are better, and the interface between the separating film and the positive electrode sheet can be more closely bonded.

Referring to FIG. 8, the method includes the following. The winding treatment is performed on the positive electrode sheet 1, the negative electrode sheet 2, and the separating film 3. The winding treatment is performed from the second edge 102 toward the first edge 101. The separating film 3 is positioned between the positive electrode sheet and the negative electrode sheet. The winding treatment includes causing the glue dots in the groups of glue dots to be in a molten state and to form adhesive layers, so that the positive electrode sheet and the separating film are fixed and/or the separating film and the negative electrode sheet are fixed.

In some embodiments, the winding treatment is to wind the separating films 3, the positive electrode sheet 1, and the negative electrode sheet 2 through a winder into a single core after the positive electrode sheet, the negative electrode sheet, and the separating film are assembled, which is achieved by that the positive electrode sheet 1 is wrapped with the negative electrode sheet 2, and the positive electrode sheet 1 and the negative electrode sheet 2 are separated by the separating films 3.

In some embodiments, during the winding treatment, a small winding tension may affect the internal resistance and inserting can rate, and excessive tension may easily lead to the risk of short circuit or fragmentation. Therefore, the winding tension is generally set as follows. A positive tension is set to be in a range of 0.08 Mpa to 0.15 Mpa, a negative tension is set to be in a range of 0.08 Mpa to 0.15 Mpa, an upper separating film tension is set to be in a range of 0.08 Mpa to 0.15 Mpa, and a lower separating film tension is set to be in a range of 0.08 Mpa to 0.15 Mpa. In addition, the negative electrode sheet 2, the positive electrode sheet 1, and the separating film 3 may have not the same width, for example, the width of the negative electrode sheet is 59.5 mm, the width of the positive electrode sheet is 58 mm, and the width of the separating film is 61 mm. The negative electrode sheet 2, the positive electrode sheet 1, and the separating film 3 are arranged to be aligned in the center to improve the alignment degree of the electrode sheets and avoid the risk of short circuit. The alignment degree of the electrode sheets refers to relative positions of the positive electrode sheet 1, the negative electrode sheet 2, and the separating film 3.

In some embodiments, the process operations of the winding treatment include a hot winding treatment and a cold pressing treatment. The hot winding treatment is configured for causing the glue dots of the plurality of groups of glue dots to be in a molten state and form adhesive layers, to fix the positive electrode sheet to the separating film and/or to fix the separating film to the negative electrode sheet. The cold pressing treatment is configured for bonding the positive electrode sheet, the negative electrode sheet, and the separating film.

It shall be noted that in order to explain and distinguish the separating film, the positive electrode sheet, and the negative electrode sheet, in FIG. 8, the separating film is illustrated by a broken line, the negative electrode sheet 2 is illustrated by a thinner solid line, and the positive electrode sheet 1 is illustrated by a thicker solid line, which do not represent the thickness relationship among the separating film, the positive electrode sheet, and the negative electrode sheet. In addition, there is a gap between the separating film 3, the positive electrode sheet 1, and the negative electrode sheet 2 in FIG. 8, which is to clearly illustrate the winding correspondence of the separating film 3, the positive electrode sheet 1, and the negative electrode sheet 2, and do not mean that there must be a gap between the separating film 3 and the positive electrode sheet 1 or between the separating film 3 and the negative electrode sheet 2. In other words, the separating film 3 and the positive electrode sheet 1 may be in contact with each other, or the separating film 3 and the negative electrode sheet 2 may be in contact with each other.

The method for preparing the energy storage cell further includes the following. The whole coil formed by winding the positive electrode sheet 1, the negative electrode sheet 2, and the separating film 3 are placed in a cavity formed by a shell, and the cavity is further filled with an electrolyte.

The electrolyte is the carrier that conducts electrons between the positive and negative electrodes in a battery. In some embodiments, the electrolyte is composed of a solvent, a lithium salt, and an additive. The solvent is used to dissolve the lithium salt, and the solvent may include a cyclic carbonate, e.g., propylene carbonate (PC), ethylene carbonate (EC); chain carbonates, e.g., diethyl carbonate (DEC), dimethyl carbonate (DMC), ethyl methyl carbonate (EMC); and carboxylic acid esters, e.g., methyl formate (MF), methyl acetate (MA), ethyl acetate (EA), methyl acrylate (MA), methylmalonic acid (MP), and the like. The lithium salt may be LiPF₆, LiClO₄, LiBF₄, LiAsF₆, or the like. The additive may include at least one of a film-forming additive, a conductive additive, a flame-retardant additive, an overcharge protection additive, an additive for controlling the content of H₂O and HF in the electrolyte, an additive for improving low-temperature performance, and a multifunctional additive.

The method includes: welding electrode tabs, where the electrode tabs are welded with an adapter sheet, another end of the adapter sheet is connected with a pole post, and the top rod is snapped into the housing. The adapter sheet is located in the chamber, and the pole post passes through a top cover.

The adapter sheet at least includes a first adapter sheet and a second adapter sheet. The pole post includes a positive pole post and a negative pole post. The first adapter sheet is electrically connected with the electrode tab of the positive electrode sheet and the positive pole post, and the second adapter sheet is electrically connected with the negative electrode tab of the negative electrode sheet and the negative pole post.

According to the method for preparing the energy storage cell provided in the present disclosure, the dispensing treatment is performed on one of the positive electrode sheet 1, the separating film 3, or the negative electrode sheet 2, and the groups of glue dots are arranged in a specific manner to alleviate and offset the stress problem caused by the bending region of the winding core, thereby avoiding the problem of wrinkles at the interface between the positive electrode sheet and the separating film and the interface between the separating film and the negative electrode sheet caused by subsequent wrinkles of the separating film, so as to improve the interface effect. Based on this uneven arrangement manner, the distribution density of the group of glue dots closer to the first edge 101 is smaller, that is, the distribution density of the position closer to the outer ring of the roll core is smaller. Therefore, the adhesive force of the glue dots between the separating film of the inner ring and the positive electrode sheet and the separating film and the negative electrode sheet can be guaranteed to be larger, and the stress caused by the bending radian can be resisted. Therefore, the positive electrode sheet and the separating film, and the separating film and the negative electrode sheet more closely bonded, thereby improving the problem that the inner ring of the winding core at the full charging interface easy to wrinkle, and reducing the dosage of glue and reducing the preparation cost.

Accordingly, according to some embodiments of the present disclosure, another aspect of the embodiment of the present disclosure also provides an energy storage cell, which can be prepared by the method provided in the above embodiments, and has the same or corresponding technical features as the above embodiments, which may not be described in detail here.

Referring to FIGS. 8 and 7, the energy storage cell includes a positive electrode sheet 1, a negative electrode sheet 2, and a separating film 3, where the separating film 3 is positioned between the positive electrode sheet 1 and the negative electrode sheet 2. The energy storage cell further includes an adhesive group including a plurality of adhesive layers 140. The adhesive layers 140 are provided between the positive electrode sheet 1 and the separating film 3 or the negative electrode sheet 2 and the separating film 3. The positive electrode sheet 1 and the separating film 3 are fixed by the adhesive layer 140 and/or the negative electrode sheet 2 and the separating film 3 are fixed by the adhesive layer 140. A distribution density of the plurality of adhesive layers decreases in the winding direction from the inner ring toward the outer ring of the cell.

The inner ring refers to an inner ring of the formed winding core structure, which corresponds to the second edge of FIG. 6. The outer ring refers to an outer ring of the formed winding core structure, which corresponds to the first edge in FIG. 6.

In the energy storage cell provided in the embodiment of the present disclosure, the glue is distributed unevenly, and the positive electrode sheet or negative electrode sheet corresponding to the outer ring and the separating film are not completely adhered, so that there is a microscopic channel between the positive electrode sheet/negative electrode sheet or the positive electrode sheet and the positive electrode sheet, and the electrolyte can directly flow to the adhered region in the middle of the electrode sheet, so that not only the electrolyte penetrates into the middle region from the edge through capillary action, thereby reducing the difficulty of infiltration of the cell, thereby improving the yield of the energy storage cell. Moreover, the channel can also be used as a gas accommodating region, so that the gas generated by the charging and discharging of the cell stays in the gas accommodating region, which can reduce the impact of the gas on the separating film and prevent the separating film from being separated from the electrode sheet. The gas containing region can also be used as a buffer region to facilitate gas seeping out, especially when the cell is not working, the gas continuously seeps out from the gas containing region to realize the emptying of the gas containing region, so as to facilitate the gas collection in the gas containing region again after the cell is charged and discharged to generate gas.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “has,” “having,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

In addition, when parts such as a layer, a film, a region, or a plate is referred to as being “on” another part, it may be “directly on” another part or may have another part present therebetween. In addition, when a part of a layer, film, region, plate, etc., is “directly on” another part, it means that no other part is positioned therebetween.

In addition, the terms “adjacent” means there is no other glue dot between the two, what are the two are next to each other in a row was sequence or arrangement. For example, A and B are two of the glue dots in the arrangement of group of the glue dots, and A is adjacent to B means there is no other glue dot between A and B, or A and B are next to each other in the group of glue dots.

It shall be understood by those skilled in the art that the above-described embodiments are specific embodiments for carrying out the present disclosure, and that various changes in form and detail may be made thereto in practical application without departing from the spirit and scope of the present disclosure. Any person skilled in the art can make various changes and modifications without departing from the spirit and scope of the present disclosure, and therefore, the scope of protection of the present disclosure should be based on the scope defined by the claims.

What is claimed is:

1. A method for preparing an energy storage cell, comprising:
providing a film layer, wherein the film layer is one of a positive electrode sheet, a separating film, and a negative electrode sheet, and the film layer has a first edge and a second edge opposite the first edge;
performing a dispensing treatment on the film layer to form a plurality of groups of glue dots arranged on a surface of the film layer in a first direction from the first edge to the second edge, wherein a distribution density of glue dots of the plurality of groups of glue dots decreases in a direction from the second edge toward the first edge;
providing remaining two of the positive electrode sheet, the separating film, and the negative electrode sheet, and stacking the negative electrode sheet, the separating film, and the positive electrode sheet sequentially to form a stacked structure; and
performing a winding treatment on the stacked structure from the second edge toward the first edge, wherein the separating film is positioned between the positive electrode sheet and the negative electrode sheet in the stacked structure, and the winding treatment includes causing the glue dots of the plurality of groups of glue dots to be in a molten state and to form adhesive layers, and fixing the separating film to at least one of the positive electrode sheet and the negative electrode sheet.

2. The method of claim 1, wherein the film layer further has two third edges disposed opposite to each other in a second direction, and each of the two third edges is connected between the first edge and the second edge;
wherein during performing of the dispensing treatment on the film layer, a distribution density of glue dots in a same group of glue dots increases in a direction from a center of the film layer in the second direction toward a corresponding third edge of the two third edges.

3. The method of claim 2, wherein a spacing between each two adjacent glue dots in the same group of glue dots decreases in the direction from the center of the film layer in the second direction toward the corresponding third edge of the two third edges.

4. The method of claim 2, wherein sizes of the glue dots in the same group of glue dots increase in the direction from the center of the film layer in the second direction toward the corresponding third edge of the two third edges.

5. The method of claim 1, wherein the plurality of groups of glue dots includes a first group of glue dots close to the first edge and a second group of glue dots close to the second edge, wherein
a size of each of first glue dots in the first group of glue dots is smaller than a size of a respective second glue dot of second glue dots of the second group of glue dots.

6. The method of claim 1, wherein the plurality of groups of glue dots includes a first group of glue dots close to the first edge and a second group of glue dots close to the second edge, wherein
a first spacing between each two adjacent first glue dots in the first group of glue dots is greater than a second spacing between a corresponding pair of adjacent second glue dots in the second group of glue dots.

7. The method of claim 6, wherein a ratio of the first spacing to the second spacing is in a range of 1.03 to 1.3.

8. The method of claim 1, wherein a total area of an orthographic projection of the plurality of groups of glue dots on the film layer accounts for 10% to 14% of a surface area of the film layer.

9. The method of claim 1, wherein the winding treatment includes: a hot winding treatment and a cold pressing treatment, wherein
the hot winding treatment includes causing the glue dots of the plurality of group of glue dots to be in the molten state and to form the adhesive layers, and fixing the separating film to at least one of the positive electrode sheet and the negative electrode sheet; and
the cold pressing treatment includes bonding the positive electrode sheet, the negative electrode sheet, and the separating film.

10. The method of claim 1, wherein the method further comprises:
before performing the winding treatment on the stacked structure,
performing a heat treatment on the film layer, wherein the heat treatment includes causing the glue dots of the plurality of groups of glue dots to be in the molten state and pre-fixing the separating film to at least one of the positive electrode sheet and the negative electrode sheet.

11. The method of claim 1, wherein during performing of the winding treatment on the stacked structure, the method further includes:
performing a heat treatment on the film layer, wherein the heat treatment includes causing the glue dots of the plurality of groups of glue dots to be in the molten state and to form the adhesive layers.

12. The method of claim 1, wherein the film layer is the positive electrode sheet or the negative electrode sheet, and before performing the dispensing treatment, the method further includes:
performing tab die-cutting on the positive electrode sheet or the negative electrode sheet to form electrode tabs adjacent to the first edge.

13. The method of claim 1, wherein each glue dot of the glue dots of the plurality of groups of glue dots has a size in a range of 0.1 mm to 0.5 mm.

14. The method of claim 13, wherein for each group of glue dots, a spacing between each two adjacent glue dots is in a range of the size of the glue dot to twice the size of the glue dot.

15. The method of claim 1, wherein the glue dots have a same size.

16. The method of claim 1, wherein during the winding treatment, a positive tension is set to be in a range of 0.08 Mpa to 0.15 Mpa, a negative tension is set to be in a range of 0.08 Mpa to 0.15 Mpa, an upper separating film tension is set to be in a range of 0.08 Mpa to 0.15 Mpa, and a lower separating film tension is set to be in a range of 0.08 Mpa to 0.15 Mpa.

17. The method of claim 1, wherein the method further comprises:
placing coil formed by winding the positive electrode sheet, the negative electrode sheet, and the separating film in a cavity formed by a shell, and injecting electrolyte into the cavity.

18. The method of claim 17, wherein the electrolyte is composed of a solvent, a lithium salt, and an additive, wherein the solvent is used to dissolve the lithium salt.

19. The method of claim 12, wherein the method further comprises:
welding the electrode tabs with an adapter sheet, wherein the adapter sheet has another end connected with a pole post, and snapping a top rod into a shell.

20. The method of claim 1, wherein the film layer is the separating film, wherein performing the dispensing treatment, providing the positive electrode sheet and the negative electrode sheet, and performing the winding treatment comprises:
providing the separating film, the positive electrode sheet, and the negative electrode sheet;
performing feeding of the separating film, the positive electrode sheet, and the negative electrode sheet sequentially;
performing the dispensing treatment on the separating film; and
performing the winding treatment on the positive electrode sheet, the negative electrode sheet, and the separating film.
